(19) United States
(12) Patent Application Publication
(10) Pub. No.: US 2020/0065932 A1
(43) Pub. Date: Feb. 27, 2020

(54) INFORMATION PROCESSING APPARATUS, INFORMATION PROCESSING METHOD AND NON-TRANSITORY STORAGE MEDIUM

(71) Applicant: TOYOTA JIDOSHA KABUSHIKI KAISHA, Toyota-shi (JP)

(72) Inventors: Akihiko NAKANISHI, Nisshin-shi (JP); Daigo FUJII, Tsushima-shi (JP); Makoto TANAKA, Toyota-shi (JP); Kazuki TAKEUCHI, Toyota-shi (JP); Chie KOIKE, Nagoya-shi (JP); Daiki KANEICHI, Nisshin-shi (JP); Tsuyoshi OKADA, Toyota-shi (JP)

(73) Assignee: TOYOTA JIDOSHA KABUSHIKI KAISHA, Toyota-shi, Aichi-ken (JP)

(21) Appl. No.: 16/527,163

(22) Filed: Jul. 31, 2019

(30) Foreign Application Priority Data
Aug. 22, 2018 (JP) 2018-155583

(51) Int. Cl. G06Q 50/30; G06Q 10/06

(52) U.S. Cl. CPC G06Q 50/30; G06Q 10/06315

(57) ABSTRACT

An information processing apparatus of the present disclosure extracts, when the number of carpool vehicles falls below a predetermined lower limit, a driver user candidate who is a candidate of a user who can let carpool demanding users carpool in a vehicle he/she drives. The information processing apparatus of the present disclosure then transmits information that requests consent to let the carpool demanding users carpool in the vehicle driven by the driver user candidate, to a terminal used by the extracted driver user candidate, that is, information for requesting consent to provide the vehicle which is owned by each driver user candidate or the ownership right of which is owned by each driver user candidate as a carpool vehicle, thereby promoting an increase in the number of carpool vehicles.

### CROSS-REFERENCE TO RELATED APPLICATIONS

This application claims the benefit of Japanese Patent Application No. 2018-155583, filed on Aug. 22, 2018 which is hereby incorporated by reference herein in its entirety.

### BACKGROUND

### Technical Field

The present disclosure relates to an information processing apparatus, an information processing method, and a non-transitory storage medium.

### Description of the Related Art

There is a known technique for determining whether or not the owners of terminals are carpooling in the same vehicle according to the positional information of each terminal and calculating the environmental impact such as CO₂ emissions and fuel consumption on the basis of the determination (e.g., see Patent Literature 1).

### CITATION LIST

### Patent Literature

Patent Literature 1: Japanese Patent Application Laid-Open No. 2011-237842

### SUMMARY

An object of the present disclosure is to provide a technique for suppressing shortages of vehicles used for carpooling in the mode in which multiple users whose purpose is to travel carpool in the same vehicle.

The present disclosure is an information processing apparatus that achieves, in a mode where multiple users carpool in the same vehicle, adjustment between the number of carpool demanding users who demand to carpool in a vehicle available for carpooling as non-drivers, and the number of vehicles used for carpooling. The information processing apparatus is provided with a controller including at least one processor. The controller is configured to execute: extracting, when the number of vehicles used for carpooling falls below a predetermined lower limit, a driver user candidate who is a candidate of a user who can let the carpool demanding users carpool in a vehicle driven by the driver user candidate; and transmitting first information that requests consent to let the carpool demanding users carpool in the vehicle driven by the driver user candidate.

The present disclosure can also be regarded as an information processing method that achieves, in a mode where multiple users carpool in the same vehicle, adjustment between the number of carpool demanding users who demand to carpool in a vehicle available for carpooling as non-drivers, and the number of vehicles used for carpooling. The information processing method in that case may be constituted so as to cause a computer to execute: a step of extracting, when the number of vehicles used for carpooling falls below a predetermined lower limit, a driver user candidate who is a candidate of a user who can let the carpool demanding users carpool in a vehicle driven by the driver user candidate; and a step of transmitting first information that requests consent to let the carpool demanding users carpool in the vehicle driven by the driver user candidate.

The present disclosure can also be regarded as an information processing program or a non-transitory storage medium that stores the information processing program, the information processing program achieving, in a mode where multiple users carpool in the same vehicle, adjustment between the number of carpool demanding users who demand to carpool in a vehicle available for carpooling as non-drivers, and the number of vehicles used for carpooling. The information processing program in that case may be constituted so as to cause a computer to execute: a step of extracting, when the number of vehicles used for carpooling falls below a predetermined lower limit, a driver user candidate who is a candidate of a user who can let the carpool demanding users carpool in a vehicle driven by the driver user candidate; and a step of transmitting first information that requests consent to let the carpool demanding users carpool in the vehicle driven by the driver user candidate.

The present disclosure provides a technique for suppressing shortages of vehicles used for carpooling in the mode in which multiple users whose purpose is to travel carpool in the same vehicle.

### BRIEF DESCRIPTION OF THE DRAWINGS

FIG. 1 is a diagram for explaining the summary of ride-sharing;

FIG. 2 is a diagram illustrating a schematic configuration of a ride-sharing system;

FIG. 3 is a diagram illustrating the hardware configurations of user terminals and a server apparatus;

FIG. 4 is a block diagram illustrating the functional configuration of the server apparatus;

FIG. 5 is a diagram illustrating a configuration example of traveling schedule information table;

FIG. 6 is a diagram illustrating a configuration example of movement schedule information table;

FIG. 7 is a diagram illustrating a configuration example of reservation information table;

FIG. 8 is a diagram illustrating another configuration example of reservation information table;

FIG. 9 is a diagram illustrating a configuration example of member information table;

FIG. 10 is a diagram illustrating an example of the state where the number of carpool vehicles goes below a predetermined lower limit;

FIG. 11 is a flow chart of processing in a server apparatus according to a first embodiment;

FIG. 12 is a diagram illustrating an example of method of extracting carpool user candidates; and

FIG. 13 is a flow chart of processing in a server apparatus according to a second embodiment.

### DESCRIPTION OF THE EMBODIMENTS

The present disclosure is an information processing apparatus that achieves, in the mode where multiple users carpool in the same vehicle, adjustment between the number of carpool demanding users, who demand to carpool in the vehicle as non-drivers, and the number of vehicles used for carpooling.

In the aforementioned ride-sharing, if the number of carpool demanding users exceeds the number of users who can carpool in a vehicle used for carpooling (hereinafter also referred to as “carpool vehicle”) as non-drivers, part of the carpool demanding users fail to carpool in the carpool vehicle, so that the convenience for the part of carpool demanding users may be degraded or the motivation of the part of carpool demanding users for using ride-sharing may decrease.

In contrast, with an information processing apparatus of the present disclosure, when the number of carpool vehicles falls below a predetermined lower limit, the controller extracts a driver user candidate who is a candidate of a user who can let carpool demanding users carpool in the vehicle he/she drives. Then, the controller transmits information (first information) that requests the consent to let carpool demanding users carpool in the vehicle driven by the driver user candidate, to the terminals used by the extracted driver user candidate. In other words, the controller makes a proposal to the extracted driver user candidate to provide the vehicle which is owned by the driver user candidate or the ownership right of which is owned by the driver user candidate, as a carpool vehicle. Hence, when a driver user candidate consents to let carpool demanding users carpool in the vehicle he/she drives, the number of carpool vehicles can be increased and the number of carpool demanding users who fail to carpool in carpool vehicles can thus be reduced. This results in suppression of shortages of carpool vehicles.

Note that a “predetermined lower limit” here corresponds to, for example, the smallest number of carpool vehicles for achieving the travel of all the carpool demanding users who demand to travel in the same time range and have their departure points and destinations on the same route (that is, the number of carpool vehicles needed for all the aforementioned carpool demanding users to ride them, assuming that a designated number of carpool demanding users are to be allowed to carpool in each carpool vehicle). For this reason, “the number of carpool vehicles falls below a predetermined lower limit” means that the aforementioned number of carpool demanding users is larger than the largest number of users that can be allowed to carpool in the aforementioned time range using all the carpool vehicles scheduled to travel on a traveling route including the aforementioned route.

In addition, in the information processing apparatus according to the present disclosure, the controller may extract the driver user candidate from the carpool demanding users. For example, the controller may extract, from the carpool demanding users, a carpool demanding user who owns a vehicle he/she can drive by himself/herself or owns the ownership right of the vehicle, as a driver user candidate. When a driver user candidate extracted in this manner consents to let carpool demanding users carpool in the vehicle he/she drives, the number of carpool vehicles can be increased and the number of carpool demanding users can thus be reduced. Consequently, the number of carpool demanding users who fail to carpool in carpool vehicles can be reduced more accurately.

Note that, when transmitting the first information to the terminal used by the driver user candidate, the controller may also transmit information on an incentive given to the driver user candidate when it is assumed that the carpool demanding users are allowed to carpool in the vehicle driven by the driver user candidate. “An incentive” here is, for example, points available for a predetermined service, electronic data of a discount ticket or gift certificate, or electronic money. Providing information on such an incentive together with the first information to the driver user candidate encourages the driver user candidate to consent to let carpool demanding users carpool in the vehicle he/she drives.

By the way, in the aforementioned ride-sharing, it can also be assumed that the number of carpool demanding users falls below the number of users who can carpool in a carpool vehicle as non-drivers. In this case, part of the users demanding carpooling of carpool demanding users in the carpool vehicles they drive (hereinafter also referred to as “drive demanding users”) fail to let carpool demanding users carpool in the carpool vehicles the drive demanding users drive, so that the convenience for drive demanding users may be degraded or the motivation of carpool demanding users for using ride-sharing may decrease.

In contrast, in an information processing apparatus according to the present disclosure, when the number of carpool vehicles exceeds a predetermined upper limit, the controller may extract a carpool user candidate who is the candidate of a user who can carpool in the vehicle another user drives, and second information for requesting the consent to carpool in the vehicle the other user drives may be transmitted to the terminal used by the extracted carpool user candidate. In other words, the controller makes a proposal to the carpool user candidate to accept a change from the travel mode by the vehicle he/she drives to the travel mode by carpooling in the carpool vehicle the other user drives. Hence, when a carpool user candidate consents to carpool in the carpool vehicle the other user drives, the number of carpool vehicles can be reduced and the number of drive demanding users who fail to let carpool demanding users carpool in the carpool vehicles they drive can thus be reduced.

A “predetermined upper limit” here corresponds to, for example, the largest number of carpool vehicles for achieving the travel of all the carpool demanding users who demand to travel in the same time range and have their departure points and destinations on the same route (that is, the number of carpool vehicles needed for all the aforementioned carpool demanding users to ride them, assuming that the smallest number of carpool demanding users (for example, one by one) are to be allowed to carpool in each carpool vehicle). For this reason, “the number of carpool vehicles exceeds a predetermined upper limit” means that the number of drive demanding users is larger than the number of users needed for driving the largest number of carpool vehicles that can let all the aforementioned carpool demanding users carpool.

In addition, in the information processing apparatus according to the present disclosure, the controller may extract a carpool user candidate from the drive demanding users. When the carpool user candidate extracted in this manner consents to carpool in the carpool vehicle the other user drives, the number of carpool vehicles can be reduced and the number of carpool demanding users can thus be increased at the same time. Consequently, the number of drive demanding users who fail to let carpool demanding users carpool in the carpool vehicles they drive can be reduced more accurately.

Note that, when transmitting the second information to the terminals used by the carpool user candidate, the controller may also transmit information on an incentive given to the carpool user candidate when it is assumed that the carpool user candidate carpools in the vehicle driven by the other user. The incentive in this case is similar to the incentive given to the driver user candidate when it is assumed that the carpool demanding users are allowed to carpool in the vehicle the driver user candidate drives.

Concrete embodiments of the present disclosure will now be described with reference to the accompanying drawings. The dimensions, materials, shapes, relative positions, and the like of the components described in the embodiments are not intended to limit the technical scope of the present disclosure thereto unless otherwise noted.

### First Embodiment

This embodiment will describe an example in which the present disclosure is implemented in a mode in which multiple users whose purpose is to travel carpool in the same vehicle (hereinafter also referred to as “ride-sharing”). Although multiple users whose purpose is to travel can carpool in a vehicle, such as an automobile or train, this embodiment will describe an example in which automobiles are targets.

(Overview of Ride-Sharing)

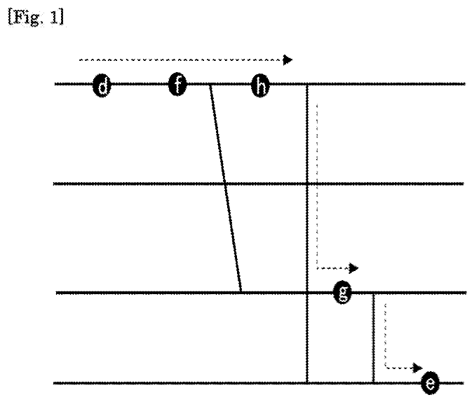

First, the overview of ride-sharing will be described with reference to FIG. 1. In the example illustrated in FIG. 1, the user A travels from the point d to the point e, the user B travels from the point f to the point g, and the user C travels from the point h to the point e.

Here, if the users A to C separately travel by their own vehicles, three vehicles are needed. In contrast, if the users A to C carpool, their travel to the respective destinations can be achieved with one vehicle. In the example illustrated in FIG. 1, the user A drives a vehicle by himself/herself to travel from the point d to the point e. At this time, the user A at the point f gets the user B into the vehicle he/she drives and, at the point h, gets the user C into the vehicle he/she drives. The user A moving the vehicle stops by the point g on the way to the point e, which is the destination of himself/herself and the user C, and drops the user B at the point g, thereby allowing the user B to travel from the departure point f to the destination point g. By moving the vehicle from the point g to the point e, the user A then allows the user C to travel form the point h to the point e while attaining the user A's own travel.

Such ride-sharing reduces the number of vehicles traveling on roads, thereby suppressing traffic jam. Further, for example, multiple users who carpooled in a vehicle share the transportation expense (for example, fuel fee) needed for the travel of the vehicle, so that the transportation expense per user can be made lower than in the case where each user travels by his/her own vehicle.

Note that the mode of ride-sharing illustrated in FIG. 1 is merely illustrative, and a combination of users carpooling a single vehicle, the traveling route of a vehicle used for carpooling (a carpool vehicle), and the like can be set by various methods. Note that, if the number of members in a group of carpool demanding users who are demanding to travel in the same time range and have their departure points and destinations on the same route (hereinafter also referred to as “carpool demanding group”) is larger than the number of users who can be allowed to carpool with all the carpool vehicles scheduled to travel on the traveling route including the aforementioned route in the aforementioned time range, part of the carpool demanding users in the aforementioned carpool demanding group fail to carpool in carpool vehicles. For this reason, the convenience for the part of carpool demanding users may decrease or the motivation of the part of carpool demanding users for using ride-sharing may decrease.

In contrast, in this embodiment, when the number of carpool vehicles falls below the predetermined lower limit, a server apparatus for information processing related to the operation and management of a ride-sharing service extracts a driver user candidate who is the candidate of a user who lets carpool demanding users carpool in the carpool vehicle he/she drives, and makes a proposal to the extracted driver user candidate to let carpool demanding users carpool in the vehicle he/she drives, thereby promoting an increase in the number of carpool vehicles.

(System Configuration)

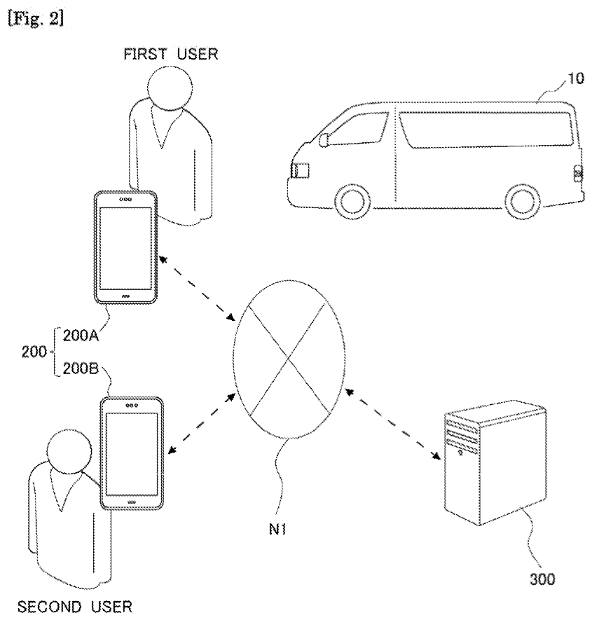

FIG. 2 is a diagram illustrating one configuration example of a system (hereinafter also referred to as “ride-sharing system”) for providing a ride-sharing service. The ride-sharing system illustrated in FIG. 2 includes a vehicle (carpool vehicle) 10 used for carpooling, user terminals 200 used by users who carpool in the carpool vehicle 10, and a server apparatus 300. The user terminals 200 and the server apparatus 300 can be connected to each other via a network N1. The network N1 may be, for example, a wide area network (WAN) which is a worldwide public communication network, such as the Internet, or other communication networks. In addition, the network N1 may include a telephone communication network such as that for cellular phones, or a wireless communication network such as Wi-Fi.

Note that, although only a single vehicle 10 is illustrated as a vehicle (carpool vehicle) used for carpooling in the example illustrated in FIG. 2, the ride-sharing service is supposed to include a certain number of carpool vehicles equal to the number of vehicles registered as vehicles available for the ride-sharing service. In addition, although only two user terminals: the first user terminal 200A used by a drive demanding user and the second user terminal 200B used by the carpool demanding user are illustrated as the user terminals 200 in the example illustrated in FIG. 2, the ride-sharing system is supposed to include a certain number of user terminals equal to the number of users registered as members who can use the ride-sharing service.

The user terminals 200 are installed with a predetermined application for using the ride-sharing service. The user of each user terminal 200 causes his/her user terminal 200 to execute the aforementioned predetermined application, thereby registering information on the conditions for carrying out carpooling (hereinafter also referred to as “request information”) to the server apparatus 300. For example, a drive demanding user causes the first user terminal 200A to execute the aforementioned predetermined application, thereby registering information on a scheduled traveling section, a scheduled traveling date and time, and the like (a traveling schedule) related to the carpool vehicle 10 he/she drives to the server apparatus 300 as request information. In addition, a carpool demanding user causes the second user terminal 200B to execute the aforementioned predetermined application, thereby registering information on a movement section, a movement date and time, and the like (a movement schedule) that he/she demands, to the server apparatus 300 as request information.

The server apparatus 300 receives request information from drive demanding users and request information from carpool demanding users. The server apparatus 300 determines a provisional combination of a drive demanding user and a carpool demanding user on the basis of request information from drive demanding users and request information from carpool demanding users. For example, the server apparatus 300 sets a route along which the carpool vehicle 10 driven by the drive demanding user travels from the departure point to the destination of the drive demanding user (a scheduled traveling route), and provisionally combines this drive demanding user with a carpool demanding user whose pickup point and drop-off point exist on the set scheduled traveling route or in the vicinity of the set scheduled traveling route. The server apparatus 300 transmits information indicating the conditions of carpooling to the user terminals 200 of the drive demanding user and the carpool demanding user in the aforementioned provisional combination. Receiving the information indicating the consent to the conditions of carpooling from the user terminals 200 of the drive demanding user and the carpool demanding user, the server apparatus 300 confirms the aforementioned provisional combination as a formal combination. In the following description, processing in which the server apparatus 300 confirms a combination of the drive demanding user and the carpool demanding user by following the aforementioned procedure will be referred to as “matching processing”. The server apparatus 300 also has, in addition to the function of performing the aforementioned matching processing, the function of performing processing for promoting an increase in the number of carpool vehicles 10 (hereinafter also referred to as “the number of vehicles adjustment processing”) when the number of carpool vehicles falls below a predetermined lower limit. The server apparatus 300 having these functions corresponds to an “information processing apparatus” according to the present disclosure.

(Hardware Configuration)

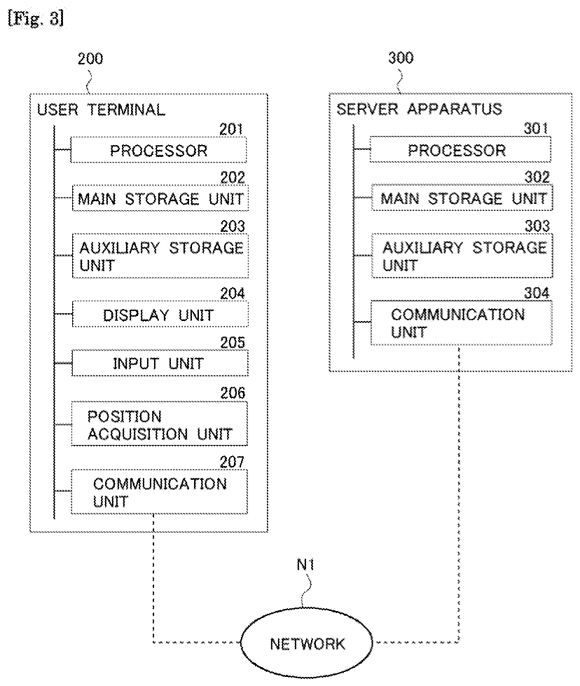

FIG. 3 is a diagram illustrating the hardware configurations of the user terminals 200 and the server apparatus 300. Note that the first user terminal 200A and the second user terminal 200B illustrated in FIG. 2 mentioned above include the same hardware configuration as the user terminal 200 illustrated in FIG. 3.

The server apparatus 300 has a typical computer configuration. In particular, the server apparatus 300 includes a processor 301, a main storage unit 302, an auxiliary storage unit 303, and a communication unit 304. They are connected to each other via a bus. The main storage unit 302 and the auxiliary storage unit 303 are computer-readable recording media. The hardware configuration of the computer is not limited to the example illustrated in FIG. 3, and appropriate omission, replacement, or addition of components may be performed.

The server apparatus 300 achieves a function meeting a predetermined objective when the processor 301 loads the programs stored in a recording medium to a work area in the main storage unit 302 and executes it so that each component or the like is controlled through the execution of the programs.

The processor 301 is a central processing unit (CPU), a digital signal processor (DSP), or the like. The processor 301 controls the server apparatus 300 and performs various calculations for information processing. The main storage unit 302 includes, for example, a random access memory (RAM) and a read only memory (ROM). The auxiliary storage unit 303 is, for example, an erasable programmable ROM (EPROM) or a hard disk drive (HDD). The auxiliary storage unit 303 can include a removable medium, that is, a portable recording medium. The removable medium is, for example, a universal serial bus (USB) memory or a disc recording medium, such as a compact disc (CD) or digital versatile disc (DVD).

The auxiliary storage unit 303 stores various programs, various types of data, and various tables in a recording medium in such a manner that they are readable and writable. The auxiliary storage unit 303 stores an operating system (OS), various programs, various tables, and the like. Note that par or all of these pieces of information may be stored in the main storage unit 302. Information stored in the main storage unit 302 may be stored in the auxiliary storage unit 303.

The communication unit 304 performs transmission and reception of information between external apparatuses and the server apparatus 300. The communication unit 304 is, for example, a local area network (LAN) interface board or a wireless communication circuit for wireless communication. The LAN interface board or the wireless communication circuit is connected to the network N1.

A sequence of processing executed in the server apparatus 300 constructed as described above can be executed using a hardware or software.

Each user terminal 200 is, for example, a smartphone, a cellular phone, a tablet terminal, a personal information terminal, a wearable computer (such as a smartwatch), or other compact computers portable by users. Note that the user terminal 200 may be a personal computer (PC) connected to the server apparatus 300 via the network N1 which is a public communication network, such as the Internet.

Each user terminal 200 includes a processor 201, a main storage unit 202, an auxiliary storage unit 203, a display unit 204, an input unit 205, a position acquisition unit 206, and a communication unit 207. Description of the processor 201, the main storage unit 202, and the auxiliary storage unit 203, which are similar to the processor 301, the main storage unit 302, and the auxiliary storage unit 303 in the server apparatus 300, will be omitted. The display unit 204 is a liquid crystal display (LCD), an electroluminescence (EL) panel, or the like. The input unit 205 includes, for example, a touch panel to which symbols such as characters can be input, a push button, a microphone to which voice can be input, and a camera capable of capturing moving images or still images. The position acquisition unit 206 is a device for acquiring the current locations of user terminals 200 and typically includes a GPS receiver, for example. The communication unit 207 is a communication circuit that accesses to the network N1 through, for example, a mobile communication service (a telecommunication network, for example, for cellular phones, or wireless communication such as Wi-Fi) for data communication with the server apparatus 300 and the like.

(Functional Configuration of Server Apparatus)

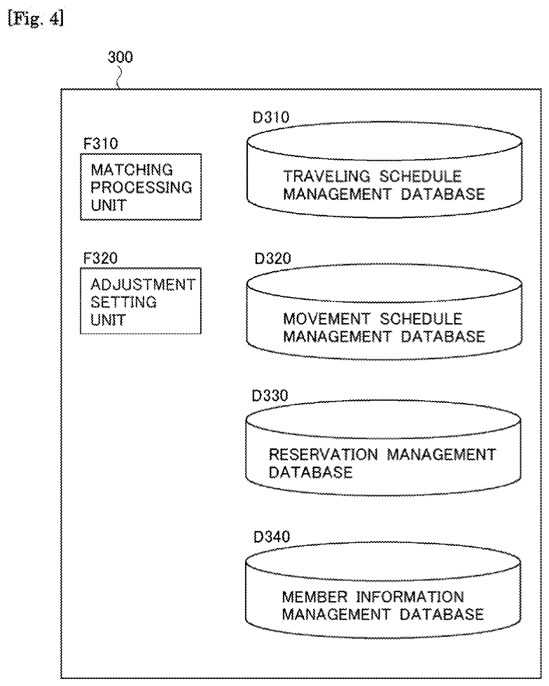

The functional configuration of the server apparatus 300 will now be described with reference to FIG. 4. As illustrated in FIG. 4, the server apparatus 300 of this embodiment includes, as its functional elements, a matching processing unit F310, an adjustment processing unit F320, a traveling schedule management database D310, a movement schedule management database D320, and a reservation management database D330. Here, the matching processing unit F310 and the adjustment processing unit F320 are formed when the processor 301 of the server apparatus 300 implements the computer programs in the main storage unit 302. Note that either the matching processing unit F310 or the adjustment processing unit F320 or part of them may be formed by a hardware circuit.

The traveling schedule management database D310, the movement schedule management database D320, the reservation management database D330, and the member information management database D340 are constructed when programs in a database management system (DBMS) executed by the processor 301 of the server apparatus 300 manage data stored in the auxiliary storage unit 303. The traveling schedule management database D310, the movement schedule management database D320, the reservation management database D330, and the member information management database D340 are relational databases, for example.

Note that any one of the functional components of the server apparatus 300 or part of their processing may be executed with another computer connected to the network N1. For example, each processing in the matching processing unit F310 and each processing in the adjustment processing unit F320 may be executed by different computers.

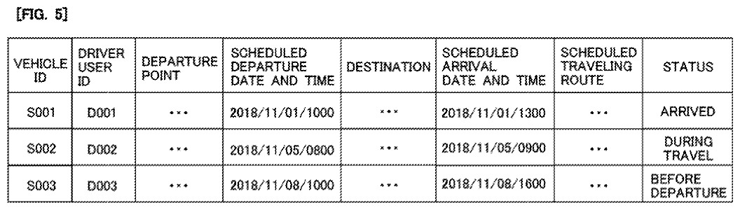

The traveling schedule management database D310 stores the traveling schedule of each carpool vehicle 10 and is where association between identification information on each drive demanding user, who is a user demanding to drive a carpool vehicle 10, and the traveling schedule of the carpool vehicle 10 is performed. An example of the configuration of traveling schedule information stored in the traveling schedule management database D310 will now be described with reference to FIG. 5. FIG. 5 is a diagram illustrating the configuration of a table of traveling schedule information. Note that information registered to a traveling schedule information table is not limited to that illustrated in FIG. 5, and appropriate addition, modification, or deletion of fields may be performed.

The traveling schedule information table illustrated in FIG. 5 includes the fields of vehicle ID, drive demanding user ID, departure point, scheduled departure period, destination, scheduled arrival date and time, scheduled traveling route, and status, for example. In the vehicle ID field, vehicle IDs which are information for identifying each carpool vehicle 10 are registered. A vehicle ID here is information given together with a user ID, which will be described later, when the drive demanding user of each carpool vehicle 10 performs membership registration to a ride-sharing service, and is information for identifying each carpool vehicle 10. In the drive demanding user ID field, user IDs which are information for identifying the drive demanding users of the carpool vehicles 10 are registered. A user ID is information given when the drive demanding user of each carpool vehicle 10 performs membership registration to a ride-sharing service. In the departure point field, information indicating the departure point of each carpool vehicle 10 is registered. Note that a departure point here is not limited a place from which a drive demanding user starts to travel by the carpool vehicle 10 and may be changed by the drive demanding user as appropriate according to his/her convenience, for example. In the scheduled departure period field, information indicating the scheduled date and time at which each drive demanding user departs from the departure point by the carpool vehicle 10 he/she drives is registered. In the destination field, information indicating the destination to which the drive demanding user heads by the carpool vehicle 10 is registered. Note that a destination here is not limited the place at which a drive demanding user ends the travel by the carpool vehicle 10 and may be changed by the drive demanding user as appropriate according to his/her convenience, for example. In the scheduled arrival date and time field, information indicating the scheduled date and time at which each drive demanding user arrives at the destination by the carpool vehicle 10 he/she drives is registered. In the scheduled traveling route field, information indicating a route through which each carpool vehicle 10 can pass from the departure point to the destination of the drive demanding user and is estimated to be able to arrive at the destination before the scheduled arrival date and time is registered. In the status field, information indicating the status of the travel of the carpool vehicle 10 by the drive demanding user is registered. For example, “arrived” is registered when the carpool vehicle 10 driven by the drive demanding user has already arrived at the destination; “during the travel” is registered when the carpool vehicle 10 driven by the drive demanding user is during the travel from the departure point to the destination; and “before departure” is registered when the carpool vehicle 10 driven by the drive demanding user is yet to depart from the departure point. Note that, for carpool vehicles 10 for which “during the travel” is registered in the status field, information on the current locations of these carpool vehicles 10 may be registered in the status field. In this case, the current location of each carpool vehicle 10 may be acquired by communication of the server apparatus 300 with the user terminal 200 of the drive demanding user, or by communication of the server apparatus 300 with a communicable device mounted in the carpool vehicle 10.

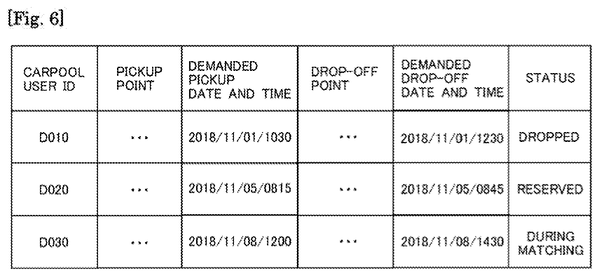

The movement schedule management database D320 stores the movement schedule of each carpool demanding user, who demands carpooling in an arbitrary carpool vehicle 10, and is where association between identification information on the carpool demanding user and the movement schedule is performed. An example of the configuration of movement schedule information stored in the movement schedule management database D320 will now be described with reference to FIG. 6. FIG. 6 is a diagram illustrating the configuration of a table of movement schedule information. Note that information registered to a movement schedule information table is not limited to that illustrated in FIG. 6, and appropriate addition, modification, or deletion of fields may be performed.

The movement schedule information table illustrated in FIG. 6 includes the fields of carpool demanding user ID, pickup point, demanded pickup date and time, drop-off point, demanded drop-off date and time, and status, for example. In the carpool demanding user ID field, user IDs for identifying each carpool demanding user are registered. Like the drive demanding user ID described above, the user ID of a carpool demanding user is information given when the carpool demanding user performs membership registration to a ride-sharing service. In the pickup point field, information indicating the location at which each carpool demanding user demands to be picked up by the carpool vehicle 10 (departure point) is registered. In the demanded pickup date and time field, information indicating the date and time at which each carpool demanding user demands to be picked up by the carpool vehicle 10 at the aforementioned pickup point is registered. In the drop-off point field, information indicating the location at which each carpool demanding user demands to be dropped out of the carpool vehicle 10 (destination) is registered. In the demanded drop-off date and time field, information indicating the date and time at which each carpool user demands to be dropped out of the carpool vehicle 10 at the aforementioned drop-off point is registered. In the status field, information indicating the status of the movement of the carpool demanding user is registered. For example, “dropped” is registered when the carpool demanding user has already dropped out of the carpool vehicle 10; “reserved” is registered when a drive demanding user to be combined with the carpool demanding user is already confirmed although the carpool demanding user is yet to be picked up by the carpool vehicle 10 this drive demanding user drives; and “during matching” is registered when a drive demanding user to be combined with the carpool demanding user is yet to be confirmed.

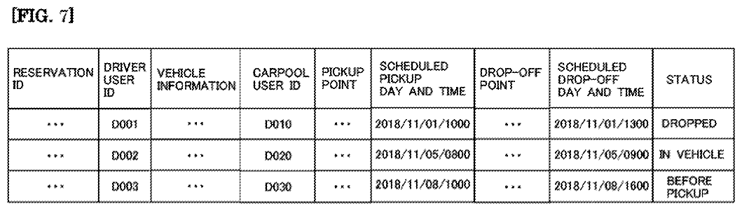

The reservation management database D330 stores ride-sharing service's reservation information, and is where association between information on each drive demanding user and information on a carpool demanding user scheduled to carpool in the carpool vehicle 10 the drive demanding user drives is performed. An example of the configuration of reservation information stored in the reservation management database D330 will now be described with reference to FIG. 7. FIG. 7 is a diagram illustrating the configuration of a table of reservation information. Note that information registered to a reservation information table is not limited to that illustrated in FIG. 7, and appropriate addition, modification, or deletion of fields may be performed.

The reservation information table illustrated in FIG. 7 includes the fields of reservation ID, drive demanding user ID, vehicle information, carpool demanding user ID, pickup point, scheduled pickup date and time, drop-off point, scheduled drop-off date and time, and status, for example. In the reservation ID field, reservation IDs which are information for identifying each piece of reservation information are registered. The reservation IDs are used when each user checks or changes the reservation, for example. In the drive demanding user ID field, user IDs for identifying the drive demanding users driving carpool vehicles 10 are registered. In the vehicle information field, information needed for each carpool demanding user scheduled to carpool a carpool vehicle 10 driven by a drive demanding user to identify the carpool vehicle 10 is registered. For example, in the vehicle information field, information on car models, car registration numbers (numbers on car registration plates), car colors, and the like is registered. In the carpool demanding user ID field, the user ID of each carpool demanding user scheduled to carpool in the carpool vehicle 10 driven by the drive demanding user is registered. In the pickup point field, information indicating the location at which each carpool demanding user is picked up by the carpool vehicle 10 driven by the drive demanding user (pickup point) is registered. In the scheduled pickup date and time field, information indicating the scheduled date and time at which each carpool demanding user is picked up at the aforementioned pickup point by the carpool vehicle 10 driven by the drive demanding user is registered. In the drop-off point field, information indicating the location at which each carpool demanding user is dropped out of the carpool vehicle 10 driven by the drive demanding user (drop-off point) is registered. In the scheduled drop-off date and time field, information indicating the scheduled date and time at which each carpool demanding user is dropped at the aforementioned pickup point out of the carpool vehicle 10 driven by the drive demanding user is registered. In the status field, information indicating the status of carpooling in each carpool vehicle 10 is registered. For example, “dropped” is registered when the carpool demanding user has already been dropped out of the carpool vehicle 10 at the aforementioned drop-off point; “in vehicle” is registered when the carpool demanding user is in the carpool vehicle 10; and “before pickup” is registered when the carpool demanding user is yet to be picked up by the carpool vehicle 10.

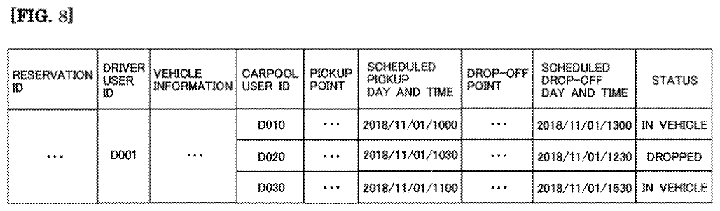

Although one carpool demanding user carpools in the carpool vehicle 10 driven by each drive demanding user is illustrated in the table configuration example of the reservation information table illustrated in FIG. 7, the number of carpool demanding users who carpool in the carpool vehicle 10 driven by each drive demanding user may be two or more. In this case, as illustrated in FIG. 8, information on multiple carpool demanding users is associated with one drive demanding user ID.

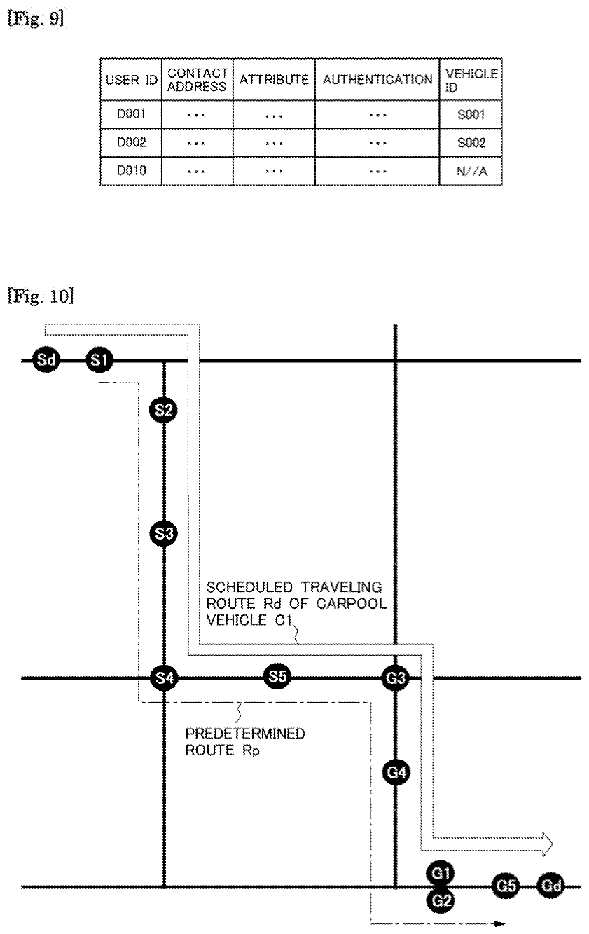

The member information management database D340 stores information on users who are membership-registered to the ride-sharing service (member information). Here, an example of the configuration of member information stored in the member information management database D340 will now be described with reference to FIG. 9. FIG. 9 is a diagram illustrating the configuration of a table of member information. Note that information registered to a member information table is not limited to that illustrated in FIG. 9, and appropriate addition, modification, or deletion of fields may be performed.

The member information table illustrated in FIG. 9 includes the fields of user ID, contact information, attribute, authentication, and vehicle ID, for example. In the user ID field, user IDs, which are given when users perform membership registration to the ride-sharing service, are registered. In the contact information field, information indicating the contact information on each user (which is, for example, an E-mail address, phone number, and the like, and includes at least the E-mail address of the user terminal 200 used by each user) is registered. In the attribute field, information indicating the attribute of each user (for example, name, nickname, age, gender, occupation, working place (school), hobby, and special skill) is registered. In the authentication field, information indicating passwords and the like needed for authentication upon registration of the aforementioned request information to the server apparatus 300 or checking of the aforementioned reservation information are registered. In the vehicle ID field, information indicating the vehicle ID of the vehicle that each user can use as a carpool vehicle 10, the designed capacity of the vehicle, and the like, i.e., information indicating the fact that he/she owns the vehicle that can be used as a carpool vehicle or has the ownership right of the vehicle is registered. Note that, for users who do not own a vehicle that can be used as a carpool vehicle 10, “N/A”, for example, is registered in the vehicle ID field.

Subsequently, the matching processing unit F310 performs matching processing on the basis of request information from drive demanding users and carpool demanding users. To be specific, when the server apparatus 300 receives request information transmitted from the user terminal 200 of a drive demanding user, the matching processing unit F310 extracts all routes that connect the departure point and the destination included in the request information, and that the carpool vehicle 10 can pass through. Next, the matching processing unit F310 selects, from the extracted routes, the route that can lead the vehicle to the aforementioned destination by the scheduled arrival date and time included in the aforementioned request information, and sets it as a scheduled traveling route. At the time, the matching processing unit F310 may set the scheduled traveling route, considering traffic congestion forecast information, traffic regulation information, and the like for the time range in which the drive demanding user travels from the departure point to the destination. Setting the scheduled traveling route in the aforementioned manner, the matching processing unit F310 generates the traveling schedule information table illustrated in FIG. 5 described above on the basis of the request information from the drive demanding user and the scheduled traveling route, and stores the generated traveling schedule information table in the traveling schedule management database D310. When the server apparatus 300 receives request information transmitted from the user terminal 200 of the carpool demanding user, the matching processing unit F310 generates the movement schedule information table illustrated in FIG. 6 described above on the basis of the request information, and stores the generated movement schedule information table in the movement schedule management database D320. The matching processing unit F310 then compares the traveling schedule information table stored in the traveling schedule management database D310 with the movement schedule information table stored in the movement schedule management database D320, and extracts a traveling schedule matching the movement schedule of each carpool demanding user. For example, the matching processing unit F310 extracts a traveling schedule information table in which the pickup point registered to the pickup point field of the movement schedule information table of the carpool demanding user, and the drop-off point registered to the drop-off point field of the movement schedule information table are present on the scheduled traveling route registered to the scheduled traveling route field. Subsequently, the matching processing unit F310 provisionally combines the drive demanding user associated with the extracted traveling schedule information table with this carpool demanding user. Upon determination of a provisional combination of the drive demanding user and the carpool demanding user in this manner, the matching processing unit F310 transmits information indicating the conditions of carpooling (for example, the pickup point for the carpool demanding user, the scheduled pickup date and time for the carpool demanding user, the drop-off point of the carpool demanding user, the scheduled drop-off date and time for the carpool demanding user, the scheduled traveling route, and the type of the carpool vehicle 10) to the user terminals 200A and 200B of the drive demanding user and the carpool demanding user in the aforementioned provisional combination. Receiving the response information indicating the consent to the aforementioned conditions of carpooling from the user terminals 200 of both the drive demanding user and the carpool demanding user, the matching processing unit F310 confirms the aforementioned provisional combination as a formal combination. In response to this, the matching processing unit F310 generates the reservation information table illustrated in FIGS. 7 and 8 described above, on the basis of the aforementioned formal combination, and stores the generated reservation information table in the reservation management database D330.

By the way, the number of carpool vehicles 10 may fall below the predetermined lower limit in the aforementioned matching processing executed in the matching processing unit F310. In other words, in the case where there are more than one carpool demanding users who demand to travel in the same time range and whose pickup point (departure point) and drop-off point (destination) are present on the same route, it is possible that the smallest number of vehicles needed to attain the travel of these carpool demanding users (in the carpool demanding group) (the number of vehicles needed for all the members in the aforementioned carpool demanding group (predetermined lower limit) to be picked up when it is assumed that the each vehicle's designed capacity of carpool demanding users are allowed to carpool in each vehicle) is larger than the number of carpool vehicles 10 scheduled to travel through a traveling route including the aforementioned route in the aforementioned time range. For example, in the example illustrated in FIG. 10, there are five carpool users whose pickup point and drop-off point are present on the predetermined route Rp: the carpool demanding user A demanding to travel from the pickup point S1 to the drop-off point G1, the carpool demanding user B demanding to travel from the pickup point S2 to the drop-off point G2, the carpool demanding user C demanding to travel from the pickup point S3 to the drop-off point G3, the carpool demanding user D demanding to travel from the pickup point S4 to the drop-off point G4, and the carpool demanding user E demanding to travel from the pickup point S5 to the destination G5. In contrast, there is only one carpool vehicle scheduled to travel through a traveling route including the predetermined route Rp: the carpool vehicle C1 scheduled to travel through the scheduled traveling route Rd from the departure point Sd to the destination Gd. Here, in the case where the designed capacity of the carpool vehicle C1 including the driver is four, the largest number of carpool demanding users who can carpool in the carpool vehicle C1 is three. For this reason, two carpool demanding users of the carpool demanding group including the carpool demanding users A to E fail to carpool the carpool vehicle C1.

Hence, when the number of carpool vehicles 10 falls below a predetermined lower limit, the adjustment processing unit F320 executes number of vehicles adjustment processing to promote an increase in the number of carpool vehicles 10. In the number of vehicles adjustment processing, the adjustment processing unit F320 first extracts the candidate (driver user candidate) of a user who can let carpool demanding users carpool in the vehicle he/she drives. In this example, the adjustment processing unit F320 extracts, from the carpool demanding group, a carpool demanding user who owns a vehicle that can be used as a carpool vehicle or who owns the ownership right of the vehicle, as the candidate of a user (driver user candidate) who can let carpool demanding users carpool in the carpool vehicle he/she drives. To be specific, the adjustment processing unit F320 accesses to the member information table (see FIG. 9 described above) of each carpool demanding user included in the aforementioned carpool demanding group, and extracts, as a driver user candidate, a carpool demanding user for whom information on the vehicle ID, designed capacity, and the like (information indicating the fact that he/she owns a vehicle that can be used as a carpool vehicle or who owns the ownership right of the vehicle) is registered in the vehicle ID field of the member information table. At the time, if there are more than one carpool demanding users for whom information on the vehicle ID, designed capacity, and the like is registered in the vehicle ID field of the member information table, the adjustment processing unit F320 extracts, from these carpool demanding users, the carpool demanding user who demands the movement section that includes the pickup points and drop-off points of the largest number of other carpool demanding users, as a driver user candidate. Here, in the example illustrated in FIG. 10 described above, if all the carpool demanding users A to E own vehicles that can be used as carpool vehicles or own the ownership rights of the vehicles, among these carpool demanding users A to E, the carpool demanding user A demands the movement section that includes the pickup points and drop-off points of the largest number of other carpool demanding users. In other words, the movement sections S1 to G1 of the carpool demanding user A include the pickup point S2 and the drop-off point G2 of the carpool demanding user B, the pickup point S3 and the drop-off point G3 of the carpool demanding user C, and the pickup point S4 and the drop-off point G4 of the carpool demanding user D. Accordingly, there are three other carpool demanding users whose pickup points and drop-off points are included in the movement sections S1 to G1 of the carpool demanding user A. The movement sections S2 to G2 of the carpool demanding user B include the pickup point S3 and the drop-off point G3 of the carpool demanding user C and the pickup point S4 and the drop-off point G4 of the carpool demanding user D. Accordingly, there are two other carpool demanding users whose pickup points and drop-off points are included in the movement sections S2 to G2 of the carpool demanding user B. Note that the movement sections S3 to G3, S4 to G4, and S5 to G5 of the carpool demanding users C to E do not include the pickup points and drop-off points of any other carpool demanding users. Accordingly, the number of other carpool demanding users whose pickup points and drop-off points are included in the movement sections S3 to G3, S4 to G4, and S5 to G5 of the carpool demanding users C to E is 0. Therefore, the adjustment processing unit F320 extracts, from the carpool demanding users A to E, the carpool demanding user A as a driver user candidate. In the case where none of the carpool demanding users A to E owns a vehicle that can be used as a carpool vehicle or owns the ownership right of the vehicle, or the number of other carpool demanding users whose pickup points and drop-off points are included in the movement sections of the carpool demanding users A to E is 0, the adjustment processing unit F320 may extract a driver user candidate from the user members out of the carpool demanding group. For example, the adjustment processing unit F320 may extract, from the user members out of the carpool demanding group, a user member who frequently travels through a traveling route including the aforementioned predetermined section R1, as a driver user candidate.

Once a driver user candidate is extracted in the above-described manner, the adjustment processing unit F320 reads the E-mail address of the user terminal 200 used by the carpool demanding user from the contact information field of the member information table of the carpool demanding user extracted as the driver user candidate, and transmits first information to that E-mail address. The “first information” here is information for requesting the consent to let carpool demanding users carpool in the vehicle he/she drives. In other words, the first information is information for requesting the consent to provide, as a carpool vehicle, the vehicle which is owned by the driver user candidate or the ownership right of which is owned by the driver user candidate. The first information can also be regarded as information for requesting the consent to change the category of the driver user candidate from a carpool demanding user to a drive demanding user. When information, as a response to the first information, indicating the consent to let carpool demanding users carpool in the vehicle he/she drives is transmitted from the user terminal 200 of the driver user candidate to the server apparatus 300, the adjustment processing unit F320 changes the category of the aforementioned driver user candidate from a carpool demanding user to a drive demanding user. To be specific, the adjustment processing unit F320 generates the traveling schedule of the driver user candidate on the basis of the movement schedule information table of the driver user candidate. At the time, the adjustment processing unit F320 generates the traveling schedule of the driver user candidate by changing the pickup point, scheduled pickup date and time, drop-off point, and scheduled drop-off date and time registered to the movement schedule information table of the driver user candidate to the departure point, scheduled departure period, destination, and scheduled arrival date and time, respectively. The traveling schedule generated in this manner is passed from the adjustment processing unit F320 to the matching processing unit F310. Accordingly, the movement schedule information table of the driver user candidate is deleted from the movement schedule management database D320.

Note that, when the information, as a response to the first information, transmitted from the user terminal 200 to the server apparatus 300 is information indicating the non-consent to let carpool demanding users carpool in the vehicle he/she drives, the adjustment processing unit F320 re-extracts, from the carpool demanding group, a carpool demanding user different from the aforementioned driver user candidate, as a new driver user candidate. For example, in the example illustrated in FIG. 10, from the group excluding the carpool demanding user A, i.e., the four carpool demanding users B to E, the carpool demanding user B who demands the movement section that includes the pickup points and drop-off points of the largest number of other carpool demanding users is extracted as a new driver user candidate.

When the traveling schedule generated in the adjustment processing unit F320 is passed to the matching processing unit F310, the matching processing unit F310 generates the traveling schedule information table of the driver user candidate in the same manner as when receiving request information from the drive demanding user, and registers the generated traveling schedule information table in the traveling schedule management database D310. At the time, a section of the predetermined route which connects the departure point and destination of the driver user candidate as described above is set as a scheduled traveling route. The matching processing unit F310 then performs matching processing based on the traveling schedule of the driver user candidate.

When the number of vehicles adjustment processing and the matching processing are performed in the aforementioned manner in the case where the number of carpool vehicles falls below the predetermined lower limit, the number of carpool vehicles can be increased while the number of members of the carpool demanding group can be reduced; thus, the number of carpool demanding users who fail to carpool in the carpool vehicle can be reduced.

(Processing Flow)

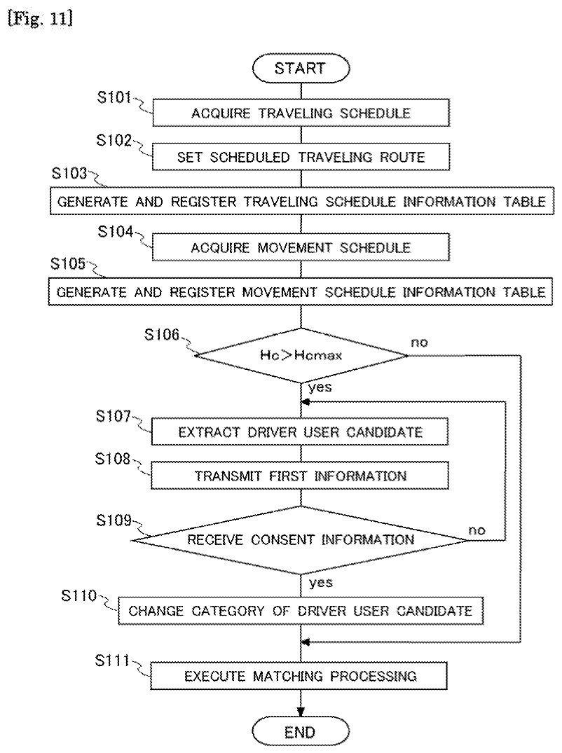

The processing flow in the server apparatus 300 according to this embodiment will now be explained with reference to FIG. 11. FIG. 11 is a flow chart of processing executed in the server apparatus 300.

In FIG. 11, the server apparatus 300 acquires the traveling schedule of each drive demanding user (Step S101). To be specific, first, on the first user terminal 200A used by each drive demanding user, the drive demanding user inputs a traveling schedule to the input unit 205, so that the traveling schedule as request information is transmitted from the communication unit 207 to the server apparatus 300. The communication unit 304 of the server apparatus 300 then receives the request information transmitted from the first user terminal 200A, thereby acquiring the traveling schedule of each drive demanding user.

In Step S102, the server apparatus 300 sets a scheduled traveling route of the carpool vehicle 10 driven by each drive demanding user on the basis of the traveling schedule acquired in Step S101 described above. To be specific, first, the matching processing unit F310 of the server apparatus 300 acquires the departure point and destination of the drive demanding user from the traveling schedule acquired in Step S101 described above. Subsequently, the matching processing unit F310 extracts all routes through which the carpool vehicle 10 can pass from the acquired departure point to destination. The matching processing unit F310 also acquires traffic congestion forecast information and traffic regulation information related to the time range during which the drive demanding user travels from the departure point to the destination, on the basis of the scheduled departure period and scheduled arrival date and time included in the traveling schedule acquired in Step S101 described above. The matching processing unit F310 then selects, from all the routes through which the carpool vehicle 10 can pass from the departure point to the destination of the drive demanding user, a route through which the drive demanding user is estimated to be able to arrive at the destination before the scheduled arrival date and time, on the basis of the traffic congestion forecast information and traffic regulation information, and sets it as a scheduled traveling route.

In Step S103, the server apparatus 300 generates the traveling schedule information table illustrated in FIG. 5 described above on the basis of the traveling schedule acquired in Step S101 described above and the scheduled traveling route set in Step S102 described above, and registers the generated traveling schedule information table to the traveling schedule management database D310.

In Step S104, the server apparatus 300 acquires the movement schedule of each carpool demanding user. To be specific, first, on the second user terminal 200B used by carpool demanding user, the carpool demanding user inputs a movement schedule to the input unit 205, so that the movement schedule as request information is transmitted from the communication unit 207 to the server apparatus 300. The communication unit 304 of the server apparatus 300 then receives the request information transmitted from the second user terminal 200B, thereby acquiring the movement schedule of each carpool demanding user.

In Step S105, the server apparatus 300 generates the movement schedule information table illustrated in FIG. 6 described above on the basis of the movement schedule acquired in Step S104 described above, and registers the generated movement schedule information table to the movement schedule management database D320.

Note that each user may register the request information to the server apparatus 300 by a method other than using the user terminal 200A or 200B, and may register the aforementioned request information to the server apparatus 300, for example, by using any terminal (for example, smartphone, mobile phone, tablet terminal, personal information terminal, or wearable computer) or personal computer (PC) that can be connected to the network N1. The acquisition of the traveling schedule of each drive demanding user and the generation of the traveling schedule information table of each drive demanding user are prior to the acquisition of the movement schedule of each carpool demanding user and the generation of the movement schedule information table of each carpool demanding user in the example illustrated in FIG. 11; however, alternatively, the acquisition of the movement schedule of each carpool demanding user and the generation of the movement schedule information table of each carpool demanding user may be prior to the acquisition of the traveling schedule of each drive demanding user and the generation of the traveling schedule information table of each drive demanding user.

In Step S106, the server apparatus 300 determines whether the number of carpool vehicles 10 is below the predetermined lower limit. To be specific, the server apparatus 300 refers to the movement schedule management database D320 and extracts all carpool demanding users who demand to travel in the same time range and whose pickup points and drop-off points are present on the same route, thereby acquiring the number of these carpool demanding users (in the carpool demanding group) Hc. The server apparatus 300 also refers to the traveling schedule management database D310 and extracts all carpool vehicles 10 scheduled to travel through a scheduled traveling route including the aforementioned route in the aforementioned time range, thereby acquiring the largest number of users who can be allowed to carpool in the extracted carpool vehicle 10 (hereinafter also referred to as “the largest number of carpool people”) Hcmax. At the time, the server apparatus 300 may calculate the largest number of carpool people Hcmax by accessing to the member information table of the drive demanding user associated with each carpool vehicle 10 scheduled to travel through a scheduled traveling route including the aforementioned route in the aforementioned time range, and referring to the designed capacity information registered to the vehicle ID field. In other words, the calculation may assume that the total number of people obtained by subtracting the number of drive demanding users (one) from the designed capacity of each carpool vehicle 10 is the largest number of carpool people Hcmax. In the case where a family member or friend of the drive demanding user is in a carpool vehicle 10 scheduled to travel through a scheduled traveling route including the aforementioned route in the aforementioned time range, the number of these people in the vehicle is subtracted in calculation of the largest number of carpool people Hcmax. If the largest number of carpool people Hcmax is below the number of people in the carpool demanding group Hc, the server apparatus 300 determines that the number of carpool vehicles 10 is below the predetermined lower limit, whereas if the largest number of carpool people Hcmax is greater than or equal to the number of people in the carpool demanding group Hc, the server apparatus 300 determines that the number of carpool vehicles 10 is not below the predetermined lower limit.

If negative determination is made in Step S106 described above, the server apparatus 300 skips Steps S107 to S110 and proceeds to Step S111. In contrast, if positive determination is made in Step S106 described above, the server apparatus 300 executes the number of vehicles adjustment processing in Steps S107 to S110.

In Step S107, the server apparatus 300 extracts a driver user candidate. The driver user candidate may be extracted using the method mentioned in the description of FIG. 10. In other words, the server apparatus 300 extracts, from the carpool demanding users in the aforementioned carpool demanding group, a carpool demanding user who owns a vehicle that can be used as a carpool vehicle or owns the ownership right of the vehicle, as a driver user candidate. At the time, if there are more than one carpool demanding users who own vehicles that can be used as carpool vehicles or own the ownership rights of the vehicles, the server apparatus 300 extracts the carpool demanding user who demands the movement section that includes the pickup points and drop-off points of the largest number of other carpool demanding users, as a driver user candidate.

In Step S108, the server apparatus 300 accesses to the member information table associated with the driver user candidate extracted in Step S107 described above to extract the E-mail address of the user terminal 200 registered to the contact information field. The server apparatus 300 then transmits first information to the extracted E-mail address. First information here is, as described above, information for requesting the consent to let other carpool demanding users carpool in the vehicle driven by the driver user candidate, that is, information for requesting the consent to provide the vehicle which is owned by the driver user candidate or the ownership right of which is owned by the driver user candidate as a carpool vehicle.

When the communication unit 304 of the server apparatus 300 receives information, as a response to the aforementioned first information, transmitted from the user terminal 200 of the driver user candidate, the server apparatus 300 determines whether the received information is consent information (information on the consent to let other carpool demanding users carpool in the vehicle driven by the driver user candidate) (Step S109).

If negative determination is made in Step S109 described above, the server apparatus 300 returns to Steps S107 and re-extracts a user different from the aforementioned driver user candidate as a new driver user candidate. In contrast, if positive determination is made in Step S109 described above, the server apparatus 300 proceeds to Step S110 and changes the category of the aforementioned driver user candidate from a carpool demanding user to a drive demanding user. To be specific, the server apparatus 300 first generates the traveling schedule information table of the driver user candidate on the basis of the movement schedule information table of the driver user candidate, and registers the generated traveling schedule information table to the traveling schedule management database D310. The method of generating and registering the traveling schedule information table at the time is the same as in Steps S102 and S103 described above.

In Step S111, the server apparatus 300 executes processing (matching processing) for determining a combination of a drive demanding user and a carpool demanding user on the basis of the traveling schedule information table registered to the traveling schedule management database D310 and the movement schedule information table registered to the movement schedule management database D320.

With the above-described flow, when the number of carpool vehicles falls below a predetermined lower limit, the number of vehicles adjustment processing for promoting an increase in the number of carpool vehicles is performed, so that the number of carpool vehicles can be increased and the number of members of the carpool demanding group can be reduced. Consequently, the number of carpool demanding users who fail to carpool in carpool vehicles can be reduced. This results in suppression of shortages of carpool vehicles.

<Modification of First Embodiment>

Note that, in the number of vehicles adjustment processing, when transmitting the first information to the user terminal 200 of a driver user candidate, the server apparatus 300 may transmit information on an incentive given to the driver user candidate when it is assumed that he/she has consented to let other carpool demanding users carpool in the vehicles he/she was driving. “An incentive” here is, for example, points available for a predetermined service, electronic data of a discount ticket or gift certificate, or electronic money. Providing information on such an incentive together with the first information to the driver user candidate encourages the driver user candidate to consent to let carpool demanding users carpool in the vehicle he/she drives. This facilitates suppression of shortages of carpool vehicles.

### Second Embodiment

The second embodiment of the information processing apparatus according to the present disclosure will now be described. Note that, in this embodiment, detailed description of the configuration and control processing substantially the same as in the first embodiment will be omitted.

This embodiment describes the example case where the number of vehicles adjustment processing is performed when the number of carpool vehicles 10 falls below a predetermined lower limit and also when the number of carpool vehicles 10 exceeds a predetermined upper limit.

Here, the number of carpool vehicles 10 may exceed the predetermined upper limit in the aforementioned matching processing executed in the matching processing unit F310. In other words, it is possible that the largest number of carpool vehicles needed to attain the travel of the carpool demanding group (the number of vehicles needed for all the members in the aforementioned carpool demanding group (predetermined upper limit) to be picked up when it is assumed that the smallest number (for example, one by one) of carpool demanding users are allowed to carpool in each vehicle) is less than the number of carpool vehicles scheduled to travel through a scheduled traveling route including the aforementioned route in the aforementioned time range. In this case, when no carpool demanding user is allowed to carpool part of the carpool vehicles scheduled to travel through the scheduled traveling route including the aforementioned route in the aforementioned time range, the convenience of the drive demanding user of the carpool vehicle may decrease and the motivation of the drive demanding user for using ride-sharing may decrease.

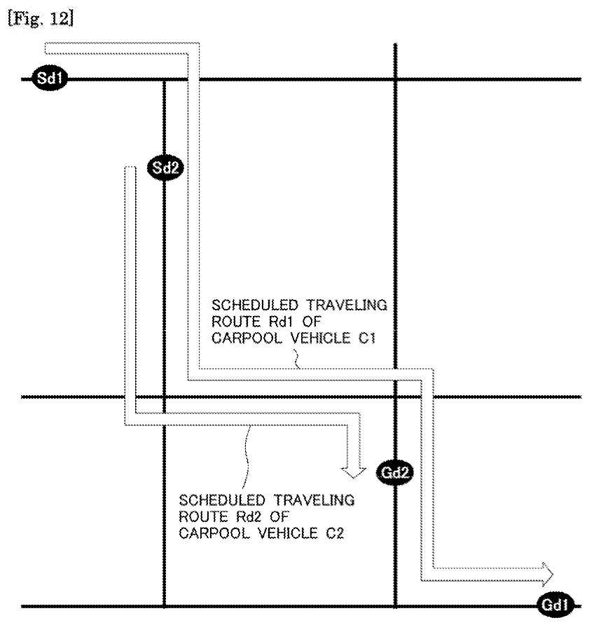

Hence, when the number of carpool vehicles 10 exceeds the predetermined upper limit, the adjustment processing unit F320 executes number of vehicles adjustment processing to promote a decrease in the number of carpool vehicles 10. In the number of vehicles adjustment processing in this case, the adjustment processing unit F320 first extracts the candidates (carpool user candidates) of users who can carpool in the carpool vehicle another drive demanding user drives. In this example, the adjustment processing unit F320 extracts, from the drive demanding users of the carpool vehicles 10 scheduled to travel through a scheduled traveling route including the aforementioned route in the aforementioned time range (hereinafter also referred to as “drive demanding group”), drive demanding users whose departure points and destinations are present on the scheduled traveling route of the carpool vehicle 10 driven by the other drive demanding user, as carpool user candidates. For example, in the example illustrated in FIG. 12, between the carpool vehicle C1 scheduled to travel through the scheduled traveling route Rd1 from the departure point Sd1 to the destination Gd1, and the carpool vehicle C2 scheduled to travel through the scheduled traveling route Rd2 from the departure point Sd2 to the destination Gd2, the drive demanding user of the carpool vehicle C2 is extracted as a carpool user candidate. This is because the departure point Sd2 and destination Gd2 of the carpool vehicle C2 are included in the scheduled traveling route Rd of the carpool vehicle C1.

Once a carpool user candidate is extracted in the above-described manner, the adjustment processing unit F320 reads the E-mail address of the user terminal 200 used by that drive demanding user from the contact information field of the member information table of the drive demanding user extracted as the carpool user candidate, and transmits second information to that E-mail address. The “second information” here is information for requesting the consent to carpool in the carpool vehicle another drive demanding user drives. In other words, the second information is information for requesting the consent to change from the travel mode using the vehicle he/she drives to the travel mode using carpooling in the carpool vehicle the other drive demanding user drives. The second information can also be regarded as information for requesting the consent to change the category of the carpool user candidate from a drive demanding user to a carpool demanding user. When information, as a response to the second information, indicating the consent to carpool in the carpool vehicle the other drive demanding user drives is transmitted from the user terminal 200 of the carpool user candidate to the server apparatus 300, the adjustment processing unit F320 changes the category of the aforementioned carpool user candidate from a drive demanding user to a carpool demanding user. To be specific, the adjustment processing unit F320 generates the movement schedule of the carpool user candidate on the basis of the traveling schedule information table of the carpool user candidate. At the time, the adjustment processing unit F320 generates the movement schedule of the carpool user candidate by changing the departure point, scheduled departure period, destination, and scheduled arrival date and time registered to the traveling schedule information table of the carpool user candidate to the pickup point, scheduled pickup date and time, drop-off point, and scheduled drop-off date and time, respectively. The movement schedule generated in this manner is passed from the adjustment processing unit F320 to the matching processing unit F310. Accordingly, the traveling schedule information table of the carpool user candidate is deleted from the traveling schedule management database D310.

Note that, when the information, as a response to the second information, transmitted from the user terminal 200 to the server apparatus 300 is information indicating the non-consent to carpool in the carpool vehicle the other drive demanding user drives, the adjustment processing unit F320 re-extracts, from the drive demanding group, a drive demanding user different from the aforementioned carpool user candidate, as a new carpool user candidate.

When no drive demanding users whose departure points and destinations are on the scheduled traveling route of the carpool vehicle 10 driven by another drive demanding user exist in the drive demanding group, the adjustment processing unit F320 may extract a carpool user candidate from the user members other than the drive demanding group. For example, the adjustment processing unit F320 may extract, from the user members out of the drive demanding group, a user member who frequently travels through a section on the aforementioned route, as a carpool user candidate.

When the movement schedule generated in the above-described manner is passed from the adjustment processing unit F320 to the matching processing unit F310, the matching processing unit F310 generates the movement schedule information table of the carpool user candidate in the same manner as when receiving request information from the carpool demanding user, and registers the generated movement schedule information table to the movement schedule management database D320. The matching processing unit F310 then performs matching processing based on the movement schedule information table of the carpool user candidate.

When the number of vehicles adjustment processing and the matching processing are performed in the aforementioned manner in the case where the number of carpool vehicles exceeds the predetermined upper limit, the number of carpool vehicles can be reduced while the number of members of the drive demanding group can be reduced; thus, the number of drive demanding users who let no carpool demanding users carpool in the carpool vehicles they drive can be reduced.

(Processing Flow)

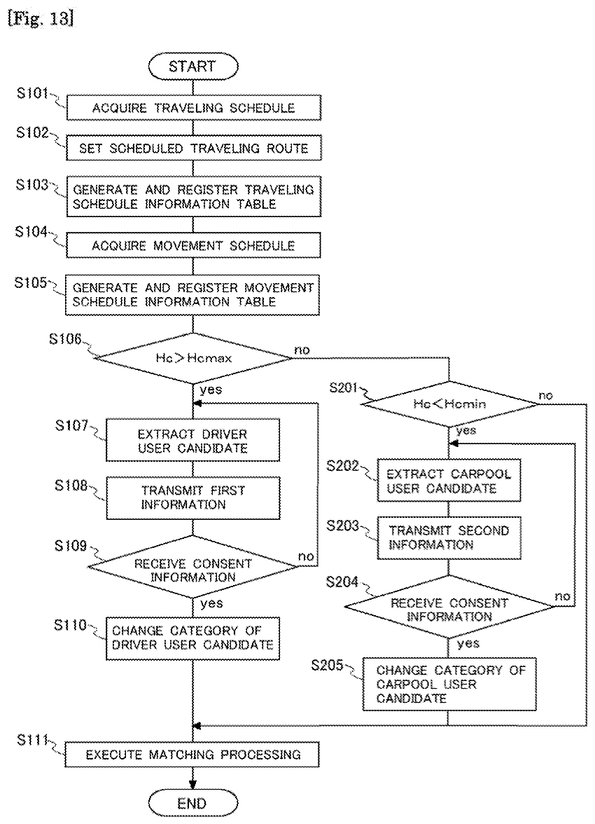

The processing flow in the server apparatus 300 according to this embodiment will now be explained with reference to FIG. 13. FIG. 13 is a processing flow executed in the server apparatus 300 according to this embodiment. In FIG. 13, the same processing as in FIG. 11 described above is denoted by the same reference numeral as the corresponding processing.

In FIG. 13, if negative determination is made in Step S106, the server apparatus 300 executes the processing in Steps S201 to S205. In Step S201, first, the server apparatus 300 determines whether the number of carpool vehicles 10 exceeds the predetermined upper limit. To be specific, the server apparatus 300 refers to the movement schedule management database D320 and extracts all carpool demanding users who demand to travel in the same time range and whose pickup points and drop-off points are present on the same route, thereby acquiring the number of these carpool demanding users (in the carpool demanding group) Hc. The server apparatus 300 also refers to the traveling schedule management database D310 and extracts all carpool vehicles 10 scheduled to travel through a scheduled traveling route including the aforementioned route in the aforementioned time range, thereby acquiring the smallest number of users who can be allowed to carpool in the extracted carpool vehicles 10 (hereinafter also referred to as “the smallest number of carpool people”) Hcmin. When it is assumed that carpool demanding users are allowed to carpool in each carpool vehicle 10 one by one, the “smallest number of carpool people Hcmin” here is the total number of carpool demanding users who can be allowed to carpool with the use of all the extracted carpool vehicles 10, and is equal to the number of extracted carpool vehicles 10. If the smallest number of carpool people Hcmin exceeds the number of people in the carpool demanding group Hc, the server apparatus 300 determines that the number of carpool vehicles 10 exceeds the predetermined upper limit, whereas if the smallest number of carpool people Hcmin is less than or equal to the number of people in the carpool demanding group Hc, the server apparatus 300 determines that the number of carpool vehicles 10 is not greater than the predetermined upper limit.

If negative determination is made in Step S201 described above, the server apparatus 300 skips Steps S202 to S205 and proceeds to Step S111. In contrast, if positive determination is made in Step S201 described above, the server apparatus 300 executes the number of vehicles adjustment processing for reducing the number of carpool vehicles 10 in Steps S202 to S205.

In Step S202, the server apparatus 300 extracts a carpool user candidate. To be specific, as in the description of FIG. 12, the server apparatus 300 extracts, from the drive demanding users of the drive demanding group, drive demanding users whose departure points and destinations are present on the scheduled traveling route of the carpool vehicle 10 driven by another drive demanding user, as carpool user candidates.

In Step S203, the server apparatus 300 accesses to the member information table associated with the carpool user candidate extracted in Step S202 described above to extract the E-mail address of the user terminal 200 registered to the contact information field. The server apparatus 300 then transmits second information to the extracted E-mail address. Second information here is, as described above, information for requesting the consent to carpool in the carpool vehicle 10 driven by another driver demanding user, that is, information for requesting the consent to change from the travel mode using the vehicle driven by the carpool user candidate himself/herself to the travel mode using carpooling in the carpool vehicle 10 driven by the other drive demanding user.

When the communication unit 304 of the server apparatus 300 receives information, as a response to the aforementioned second information, transmitted from the user terminal 200 of the carpool user candidate, the server apparatus 300 determines whether the received information is consent information (information on the consent to carpool in the carpool vehicle 10 driven by the other driver demanding user) (Step S204).

If negative determination is made in Step S204 described above, the server apparatus 300 returns to Steps S202 and re-extracts a drive demanding user different from the aforementioned carpool user candidate as a new carpool user candidate. In contrast, if positive determination is made in Step S204 described above, the server apparatus 300 proceeds to Step S205 and changes the category of the aforementioned carpool user candidate from a drive demanding user to a carpool demanding user. To be specific, the server apparatus 300 first generates the movement schedule information table of the carpool user candidate on the basis of the traveling schedule information table of the carpool user candidate, and registers the generated movement schedule information table to the movement schedule management database D320. The method of generating and registering the movement schedule information table at the time is the same as in Step S105 described above.

With the above-described flow, when the number of carpool vehicles falls below a predetermined lower limit, the number of vehicles adjustment processing for promoting an increase in the number of carpool vehicles is performed, whereas when the number of carpool vehicles exceeds a predetermined upper limit, the number of vehicles adjustment processing for promoting a decrease in the number of carpool vehicles is performed. Hence, when the number of carpool vehicles falls below a predetermined lower limit, the number of carpool vehicles can be increased and the number of members of the carpool demanding group can be reduced, whereas when the number of carpool vehicles exceeds a predetermined upper limit, the number of carpool vehicles can be reduced and the number of members of the carpool demanding group can be increased. This results in suppression of excesses or shortages of carpool vehicles.

<Modification of Second Embodiment>

Note that, in the number of vehicles adjustment processing for promoting a decrease in the number of carpool vehicles, when transmitting the second information to the user terminal 200 of a carpool user candidate, the server apparatus 300 may transmit information on an incentive given to the carpool user candidate when it is assumed that he/she has consented to carpool in the carpool vehicle driven by another drive demanding user. “An incentive” here is, for example, points available for a predetermined service, electronic data of a discount ticket or gift certificate, or electronic money. Providing information on such an incentive together with the second information to the carpool user candidate encourages the carpool user candidate to consent to carpool in the carpool vehicle driven by the other drive demanding user. This facilitates suppression of the excessive number of carpool vehicles.

<Others>

Note that the above-described embodiment is merely illustrative and appropriate modification can be made without departing from the scope of the present disclosure.

The processing and means described in this disclosure can be freely combined unless inconsistencies arise. In addition, processing supposed to be done with one apparatus according to the above description may be executed with multiple apparatuses. Alternatively, processing supposed to be done with different apparatuses according to the above description may be executed with one apparatus. In a computer system, the type of hardware configuration used to implement each function can be flexibly changed.

The present disclosure can be implemented when a computer program having the functions that have been described in the above embodiments and modifications is supplied to a computer, and one or more processors in the computer read and execute the program. Such a computer program may be provided to the computer via a non-transitory computer-readable storage medium that can be connected to the computer's system bus or via a network. A non-transitory computer-readable storage medium is a recording medium that can accumulate information, such as data and programs, electrically, magnetically, optically, mechanically, or chemically and read it from a computer or the like; examples include any type of disks such as magnetic disks (such as floppy (registered trademark) disks and hard disk drives (HDDs)), and optical discs (such as CD-ROMs, DVD discs, and Blu-ray discs), read only memories (ROMs), random access memories (RAMS), EPROMs, EEPROMs, magnetic cards, flash memories, optical cards, and solid state drives (SSDs).

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

What is claimed is:

1. An information processing apparatus that achieves, in a mode where multiple users carpool in the same vehicle, adjustment between the number of carpool demanding users who demand to carpool in a vehicle used for carpooling as non-drivers, and the number of vehicles used for carpooling, the information processing apparatus comprising a controller including at least one processor,
the controller configured to execute:
extracting, when the number of vehicles used for carpooling falls below a predetermined lower limit, a driver user candidate who is a candidate of a user who can let the carpool demanding users carpool in a vehicle driven by the driver user candidate; and
transmitting first information that requests consent to let the carpool demanding users carpool in the vehicle driven by the driver user candidate, to a terminal used by the driver user candidate.

2. An information processing apparatus according to claim 1, wherein the controller extracts the driver user candidate from the carpool demanding users.

3. An information processing apparatus according to claim 1, wherein, when transmitting the first information to the terminal used by the driver user candidate, the controller also transmits information on an incentive given to the driver user candidate when it is assumed that the carpool demanding users are allowed to carpool in the vehicle driven by the driver user candidate.

4. An information processing apparatus according to claim 2, wherein, when transmitting the first information to the terminal used by the driver user candidate, the controller also transmits information on an incentive given to the driver user candidate when it is assumed that the carpool demanding users are allowed to carpool in the vehicle driven by the driver user candidate.

5. The information processing apparatus according to claims 1, wherein
when the number of vehicles used for carpooling exceeds a predetermined upper limit, the controller extracts a carpool user candidate who is a candidate of a user who can carpool in a vehicle driven by another user, and
the controller transmits second information that requests consent to carpool in the vehicle driven by the other user, to a terminal used by the carpool user candidate.

6. The information processing apparatus according to claim 4, wherein the controller extracts the carpool user candidate from drive demanding users who demand to drive vehicles used for carpooling.

7. The information processing apparatus according to claim 4, wherein, when transmitting the second information to the terminal used by the carpool user candidate, the controller also transmits information on an incentive given to the carpool user candidate when it is assumed that the carpool user candidate carpools in the vehicle driven by the other user.

8. The information processing apparatus according to claim 5, wherein, when transmitting the second information to the terminal used by the carpool user candidate, the controller also transmits information on an incentive given to the carpool user candidate when it is assumed that the carpool user candidate carpools in the vehicle driven by the other user.

9. An information processing method that achieves, in a mode where multiple users carpool in the same vehicle, adjustment between the number of carpool demanding users who demand to carpool in a vehicle available for carpooling as non-drivers, and the number of vehicles used for carpooling,
the information processing method being constituted so as to cause a computer to execute:
a step of extracting, when the number of vehicles used for carpooling falls below a predetermined lower limit, a driver user candidate who is a candidate of a user who can let the carpool demanding users carpool in a vehicle driven by the driver user candidate; and
a step of transmitting first information that requests consent to let the carpool demanding users carpool in the vehicle driven by the driver user candidate, to a terminal used by the driver user candidate.

10. A non-transitory storage medium that stores an information processing program that achieves, in a mode where multiple users carpool in the same vehicle, adjustment between the number of carpool demanding users who demand to carpool in a vehicle available for carpooling as non-drivers, and the number of vehicles used for carpooling,
the information processing program being constituted so as to cause a computer to execute:
a step of extracting, when the number of vehicles used for carpooling falls below a predetermined lower limit, a driver user candidate who is a candidate of a user who can let the carpool demanding users carpool in a vehicle driven by the driver user candidate, and
a step of transmitting first information that requests consent to let the carpool demanding users carpool in the vehicle driven by the driver user candidate, to a terminal used by the driver user candidate.
